(19) United States
(12) Patent Application Publication
(10) Pub. No.: US 2020/0187095 A1
(43) Pub. Date: Jun. 11, 2020

(54) WI-FI HOTSPOT SHARING METHOD FOR TERMINAL, AND TERMINAL

(71) Applicant: JRD COMMUNICATION (SHENZHEN) LTD, Shenzhen, Guangdong (CN)

(72) Inventor: Hengchang Zhao, Shenzhen, Guangdong (CN)

(21) Appl. No.: 16/333,241

(22) PCT Filed: Sep. 28, 2017
(86) PCT No.: PCT/CN2017/103962

§ 371 Date: Mar. 14, 2019

(30) Foreign Application Priority Data
Nov. 2, 2016 (CN) 201610952329.7

(51) Int. Cl. H04W 48/14; H04W 24/02; H04W 48/16; H04W 84/12; H04W 4/80; H04W 8/00; H04W 48/02

(52) U.S. Cl. CPC H04W 48/14; H04W 24/02; H04W 48/16; H04W 48/02; H04W 4/80; H04W 8/005; H04W 84/12

(57) ABSTRACT

The present disclosure provides a Wi-Fi hotspot sharing method for a terminal, and a terminal. The method may include setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot. Thereby, a Wi-Fi hotspot may be conveniently connected and to a user requirement that to hide a Wi-Fi hotspot may be met, so that user experience may be enhanced.

### FIELD

The described embodiments relate to a mobile terminal technology, and more particularly, to a Wi-Fi hotspot sharing method for a terminal, and a terminal.

### BACKGROUND

In a modern life, smart phone devices have a function of “network sharing and portable hotspot”, which means that a mobile phone may shared its network with other devices by a function of wireless local area networks (WLAN). Thereby other devices may access the internet through a connection of the mobile phone.

When a user wants to share his network, the user sets a service set identifier (SSID, as a Wi-Fi hotspot name), a password, and Wi-Fi hotspot visibility in the “network sharing and portable hotspot” option in his mobile phone (i.e., the user sets whether to share this wireless network to anyone, or whether to hide the Wi-Fi hotspot).

The user may have reasons to set the Wi-Fi hotspot set to hide. The Wi-Fi hotspot set to hide may also enhance security of the Wi-Fi hotspot to some extent, because the Wi-Fi hotspot is hidden, other devices cannot search the Wi-Fi hotspot. When a Wi-Fi hotspot is hidden (i.e., wireless network of the Wi-Fi hotspot does not share to anyone), for a device that wants to connect to the Wi-Fi hotspot, a user needs to manually enter the SSID of the Wi-Fi hotspot to connect. It is not convenient to use.

### SUMMARY

The present disclosure provides a Wi-Fi hotspot sharing method for a terminal, and a terminal, to conveniently connect to a Wi-Fi hotspot and to meet a user requirement that to hide a Wi-Fi hotspot, so as to enhance user experience.

In order to solve the above-mentioned purpose, a technical solution adopted by the present disclosure is to provide a Wi-Fi hotspot sharing method for a terminal, including setting a Wi-Fi hotspot of the terminal as a hidden hotspot; determining whether a hotspot conversion request is received from a device other than the terminal; when the device other than the terminal requests for a near field communication to the terminal, or when the device other than the terminal sends a preset short message to the terminal, setting the Wi-Fi hotspot of the terminal as a visible hotspot.

In order to solve the above-mentioned purpose, a technical solution adopted by the present disclosure is further to provide a Wi-Fi hotspot sharing method for a terminal, including setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot.

In order to solve the above-mentioned purpose, a technical solution adopted by the present disclosure is further to provide a terminal, including a communication circuit; a memory; and a processor; wherein the communication circuit and the memory are coupled to the processor; the processor is configured to perform operations including setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot.

Advantages of the disclosure may follow. As compared with the related art, the present disclosure may provide a Wi-Fi hotspot sharing method for a terminal, including setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot. Thereby, a Wi-Fi hotspot may be conveniently connected and to a user requirement that to hide a Wi-Fi hotspot may be met, so that user experience may be enhanced.

### BRIEF DESCRIPTION OF THE DRAWINGS

FIG. 1 is a flow chart of a Wi-Fi hotspot sharing method for a terminal in accordance with an embodiment in the present disclosure.

FIG. 2 is a specific flow chart in the operation S200 in FIG. 1 of a Wi-Fi hotspot sharing method for a terminal in accordance with an embodiment in the present disclosure.

FIG. 3 is another specific flow chart in an operation S200A in FIG. 1 of a Wi-Fi hotspot sharing method for a terminal in accordance with an embodiment in the present disclosure.

FIG. 4 is a specific flow chart after an operation S300 in FIG. 1 of a Wi-Fi hotspot sharing method for a terminal in accordance with an embodiment in the present disclosure.

FIG. 5 is a specific flow chart after an operation S300 in FIG. 1 of a Wi-Fi hotspot sharing method for a terminal in accordance with an embodiment in the present disclosure.

FIG. 6 is an application scenario of a Wi-Fi hotspot sharing method for a terminal in accordance with an embodiment in the present disclosure.

FIG. 7 is a structural illustration of a terminal in accordance with an embodiment in the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments.

FIG. 1 illustrates a flow chart of a Wi-Fi hotspot sharing method for a terminal in accordance with an embodiment in the present disclosure. The method may include operations in the following blocks.

Block S100, a Wi-Fi hotspot of a terminal may be set as a hidden hotspot.

Block S200, whether a hotspot conversion request is received from a device other than the terminal, may be determined.

Block S300, when the hotspot conversion request is received from the device other than the terminal, the Wi-Fi hotspot of the terminal may be set as a visible hotspot.

In this embodiment, the Wi-Fi hotspot may allow a device to connect to a WLAN, which may use the radio frequency band of 2.4G ultra high frequency (UHF) or 5G super high frequency (SHF) industrial scientific medical band (ISM). In this embodiment, a connection to the WLAN may be password protected, or may be open. An open WLAN may allow any device located in a range of the WLAN to connect.

In the above-mentioned embodiment, a Wi-Fi hotspot sharing method for a terminal may include setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot. Thereby, a Wi-Fi hotspot may be conveniently connected and to a user requirement that to hide a Wi-Fi hotspot may be met, so that user experience may be enhanced.

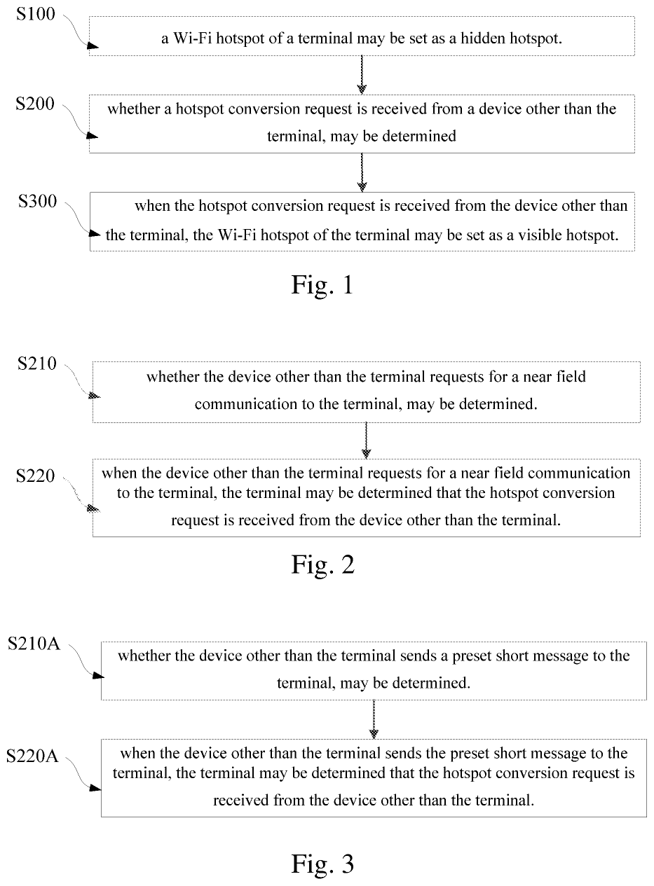

FIG. 2 illustrates a specific flow chart in the operation S200 in FIG. 1 of a Wi-Fi hotspot sharing method for a terminal in accordance with an embodiment in the present disclosure. In at least one embodiment, the method may further include operations in the following blocks.

Block S210, whether the device other than the terminal requests for a near field communication to the terminal, may be determined.

Block S220, when the device other than the terminal requests for a near field communication to the terminal, the terminal may be determined that the hotspot conversion request is received from the device other than the terminal.

In this embodiment, The near field communication (NFC) is evolved from contactless radio frequency identification (RFID) technology, and is developed by Philips Semiconductors (now NXP Semiconductors), Nokia, and Sony, based on the RFID technology and an interconnect technology. The NFC is a short-range high-frequency radio technology that operates at a distance of 10 cm at a frequency of 13.56 MHz. The NFC has a transmission speed of 106 Kbit/s, 212 Kbit/s or 424 Kbit/s. In the related art, the NFC has passed the ISO/IEC IS 18092 international standard, the ECMA-340 standard, and the ETSI TS 102 190 standard. The NFC adopts both active and passive read modes.

In this embodiment, the NFC combines an inductive reader function, an inductive card function, and point-to-point function, to be integrated in a single chip, so as to identify and exchange data with compatible devices over short distances. An operation frequency of the NFC is 13.56 MHz, but users adopted this mobile payment solution must replace a special mobile phone. The NFC technology is currently widely used in Japan and South Korea. Mobile phone users may travel all over the country with their mobile phones having payment functions. The Mobile phone user may use their mobile phone as airport check-in verification, a building access key, a traffic card, a credit card, a payment card, and so on.

FIG. 3 illustrates a specific flow chart in the operation S200A in FIG. 1 of a Wi-Fi hotspot sharing method for a terminal in accordance with an embodiment in the present disclosure. The method may further include operations in the following blocks.

Block S210A, whether the device other than the terminal sends a preset short message to the terminal, may be determined.

Block S220A, when the device other than the terminal sends the preset short message to the terminal, the terminal may be determined that the hotspot conversion request is received from the device other than the terminal.

When the NFC is not configured on a terminal, it may also adopt to send a preset short message. In practical applications, it may also adopt to send an instant message, and so on.

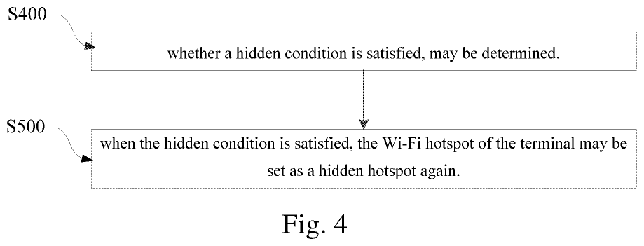

FIG. 4 is a specific flow chart after an operation S300 in FIG. 1 of a Wi-Fi hotspot sharing method for a terminal in accordance with an embodiment in the present disclosure. In at least one embodiment, the method may further include operations in the following blocks.

Block S400, whether a hidden condition is satisfied, may be determined.

Block S500, when the hidden condition is satisfied, the Wi-Fi hotspot of the terminal may be set as a hidden hotspot again.

When the hidden condition is satisfied, the Wi-Fi hotspot of the terminal may be set as a hidden hotspot again, to re-satisfy security requirements of users.

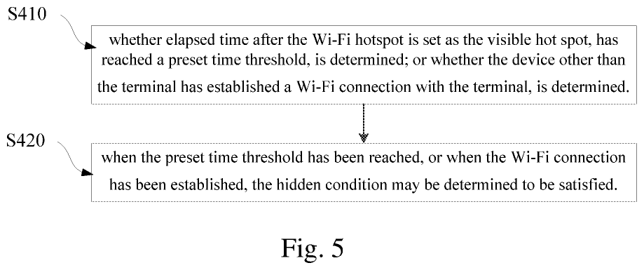

FIG. 5 is a specific flow chart after an operation S300 in FIG. 1 of a Wi-Fi hotspot sharing method for a terminal in accordance with an embodiment in the present disclosure. In at least one embodiment, the method may further include operations in the following blocks.

Block S410, whether elapsed time after the Wi-Fi hotspot is set as the visible hot spot, has reached a preset time threshold, is determined; or whether the device other than the terminal has established a Wi-Fi connection with the terminal, is determined.

Block S420, when the preset time threshold has been reached, or when the Wi-Fi connection has been established, the hidden condition may be determined to be satisfied.

In one case, when the elapsed time after the Wi-Fi hotspot is set as the visible hot spot, has reached a preset time threshold, the device other than the terminal may also have been connected to the terminal, and devices other than the terminal that are not connected to the terminal, may also not require to connect to the terminal. In another case, the device other than the terminal has established a Wi-Fi connection with the terminal. In the above-mentioned two cases, the hidden condition may be determined to be satisfied.

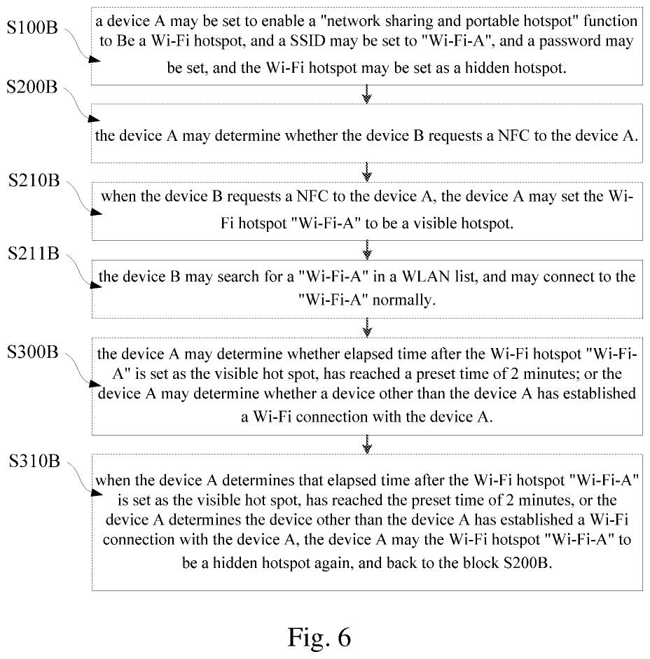

FIG. 6 is an application scenario of a Wi-Fi hotspot sharing method for a terminal in accordance with an embodiment in the present disclosure. In the application scenario, a device A is configured to be a Wi-Fi hotspot (a wireless access point), and a device B wants to connect to the Wi-Fi hotspot of the device A. A user may brings the device B close to the device A, and the device A may find an NFC device that try connect to itself, so that the device A may change itself from a hidden hotspot to a visible hotspot.

Specific operations in this application scenario may be described in the following blocks.

Block S100B, a device A may be set to enable a “network sharing and portable hotspot” function to be a Wi-Fi hotspot, and a SSID may be set to “Wi-Fi-A”, and a password may be set, and the Wi-Fi hotspot may be set as a hidden hotspot.

Block S200B, the device A may determine whether the device B requests a NFC to the device A.

Block S210B, when the device B requests a NFC to the device A, the device A may set the Wi-Fi hotspot “Wi-Fi-A” to be a visible hotspot.

Block S211B, the device B may search for a “Wi-Fi-A” in a WLAN list, and may connect to the “Wi-Fi-A” normally.

Block S300B, the device A may determine whether elapsed time after the Wi-Fi hotspot “Wi-Fi-A” is set as the visible hot spot, has reached a preset time of 2 minutes; or the device A may determine whether a device other than the device A has established a Wi-Fi connection with the device A.

Block S310B, when the device A determines that elapsed time after the Wi-Fi hotspot “Wi-Fi-A” is set as the visible hot spot, has reached the preset time of 2 minutes, or the device A determines the device other than the device A has established a Wi-Fi connection with the device A, the device A may the Wi-Fi hotspot “Wi-Fi-A” to be a hidden hotspot again, and back to the block S200B.

In addition, in other application scenarios, a device A may be configured to be a Wi-Fi hotspot (a wireless access point), and a device B wants to connect to the Wi-Fi hotspot of the device A. A user may bring the device A close to an NFC tag, and the device A may find an NFC device that try connect to itself, so that the device A may change itself from a hidden hotspot to a visible hotspot.

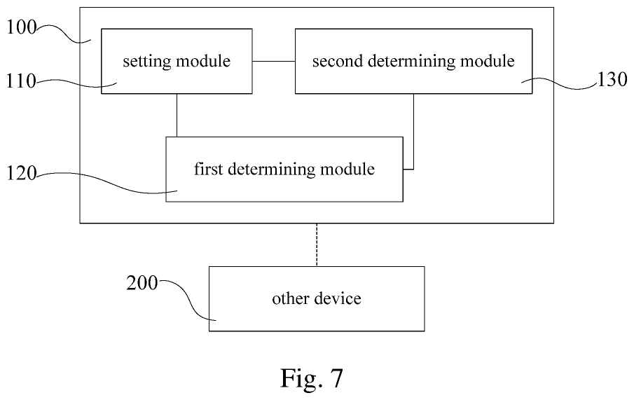

FIG. 7 illustrates a structural illustration of a terminal in accordance with an embodiment in the present disclosure. In this embodiment, a terminal may perform the above-mentioned operations. Details may refer to the above-mentioned descriptions, therefore no additional description is given herein.

In this embodiment, a terminal device 100 may include a setting module 110 and a first determining module 120.

The setting module 110 may be configured to set a Wi-Fi hotspot of the terminal 100 as a hidden hotspot.

The first determining module 120 may be configured to determine whether a hotspot conversion request is received from a device 200 other than the terminal 100.

When the hotspot conversion request is received from the device 200 other than the terminal 100, the setting module 110 may set the Wi-Fi hotspot of the terminal 100 as a visible hotspot.

In the above-mentioned embodiment, a Wi-Fi hotspot sharing method for a terminal may include setting a Wi-Fi hotspot of the terminal as a hidden hotspot; determining whether a hotspot conversion request is received from a device other than the terminal; when the hotspot conversion request is received from the device other than the terminal, setting the Wi-Fi hotspot of the terminal as a visible hotspot. Thereby, a Wi-Fi hotspot may be conveniently connected and to a user requirement that to hide a Wi-Fi hotspot may be met, so that user experience may be enhanced.

In at least one embodiment, the first determining module 120 may be configured to determine whether the device 200 other than the terminal 100 requests for a NFC to the terminal 100. When the device other 200 than the terminal 100 requests for a NFC to the terminal 100, the first determining module 120 may determine that the hotspot conversion request is received from the device 200 other than the terminal 100.

In at least one embodiment, the first determining module 120 may be configured to determine whether the device 200 other than the terminal 100 sends a preset short message to the terminal 100. When the device 200 other than the terminal 100 sends the preset short message to the terminal 100, the first determining module may determine that the hotspot conversion request is received from the device 200 other than the terminal 100.

The terminal 100 may further include a second determining module 130. The second determining module 130 may be configured to determine whether a hidden condition is satisfied, after the setting module 110 set the Wi-Fi hotspot of the terminal 100 as the visible hotspot. When the hidden condition is satisfied, the setting module 110 may set the Wi-Fi hotspot of the terminal 100 as a hidden hotspot again.

The second determining module may further be configured to determine whether elapsed time after the Wi-Fi hotspot is set as the visible hot spot, has reached a preset time threshold, or may further be configured to determine whether the device 200 other than the terminal 100 has established a Wi-Fi connection with the terminal 100. When the preset time threshold has been reached, or when the Wi-Fi connection has been established, the second determining module 130 may determine that the hidden condition is satisfied.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

1. A Wi-Fi hotspot sharing method for a terminal, comprising:
setting a Wi-Fi hotspot of the terminal as a hidden hotspot;
determining whether a hotspot conversion request is received from a device other than the terminal;
when the device other than the terminal requests for a near field communication to the terminal, or when the device other than the terminal sends a preset short message to the terminal, setting the Wi-Fi hotspot of the terminal as a visible hotspot.

2. The method according to claim 1, wherein
after the setting the Wi-Fi hotspot of the terminal as the visible hotspot, the method further comprises:
determining whether a hidden condition is satisfied;
when the hidden condition is satisfied, setting the Wi-Fi hotspot of the terminal as a hidden hotspot again.

3. The method according to claim 2, wherein
the determining whether the hidden condition is satisfied, comprises:
determining whether elapsed time after the Wi-Fi hotspot is set as the visible hot spot, has reached a preset time threshold, or determining whether the device other than the terminal has established a Wi-Fi connection with the terminal;
when the preset time threshold has been reached, or when the Wi-Fi connection has been established, the hidden condition is determined to be satisfied.

4. A Wi-Fi hotspot sharing method for a terminal, comprising:
setting a Wi-Fi hotspot of the terminal as a hidden hotspot;
determining whether a hotspot conversion request is received from a device other than the terminal;
when the hotspot conversion request is received from the device other than the terminal, setting the Wi-Fi hotspot of the terminal as a visible hotspot.

5. The method according to claim 4, wherein
the determining whether the hotspot conversion request is received from the device other than the terminal, comprises:
determining whether the device other than the terminal requests for a near field communication to the terminal;
when the device other than the terminal requests for a near field communication to the terminal, the terminal is determined that the hotspot conversion request is received from the device other than the terminal.

6. The method according to claim 4, wherein
the determining whether the hotspot conversion request is received from the device other than the terminal, comprises:
determining whether the device other than the terminal sends a preset short message to the terminal;
when the device other than the terminal sends the preset short message to the terminal, the terminal is determined that the hotspot conversion request is received from the device other than the terminal.

7. The method according to claim 4, wherein
after the setting the Wi-Fi hotspot of the terminal as the visible hotspot, the method further comprises:
determining whether a hidden condition is satisfied;
when the hidden condition is satisfied, setting the Wi-Fi hotspot of the terminal as a hidden hotspot again.

8. The method according to claim 7, wherein
the determining whether the hidden condition is satisfied, comprises:
determining whether elapsed time after the Wi-Fi hotspot is set as the visible hot spot, has reached a preset time threshold, or determining whether the device other than the terminal has established a Wi-Fi connection with the terminal;
when the preset time threshold has been reached, or when the Wi-Fi connection has been established, the hidden condition is determined to be satisfied.

9. A terminal, comprising:
a communication circuit;
a memory; and
a processor;
wherein
the communication circuit and the memory are coupled to the processor;
the processor is configured to perform operations comprising:
setting a Wi-Fi hotspot of the terminal as a hidden hotspot;
determining whether a hotspot conversion request is received from a device other than the terminal;
when the hotspot conversion request is received from the device other than the terminal, setting the Wi-Fi hotspot of the terminal as a visible hotspot.

10. The terminal according to claim 9, wherein
the operations further comprise:
determining whether the device other than the terminal requests for a near field communication to the terminal;
when the device other than the terminal requests for a near field communication to the terminal, the terminal is determined that the hotspot conversion request is received from the device other than the terminal.

11. The terminal according to claim 9, wherein
the operations further comprise:
determining whether the device other than the terminal sends a preset short message to the terminal;
when the device other than the terminal sends the preset short message to the terminal, the terminal is determined that the hotspot conversion request is received from the device other than the terminal.

12. The terminal according to claim 9, wherein
the operations further comprise:
determining whether a hidden condition is satisfied;
when the hidden condition is satisfied, setting the Wi-Fi hotspot of the terminal as a hidden hotspot again.

13. The terminal according to claim 12, wherein
the operations further comprise:
determining whether elapsed time after the Wi-Fi hotspot is set as the visible hot spot, has reached a preset time threshold, or determining whether the device other than the terminal has established a Wi-Fi connection with the terminal;
when the preset time threshold has been reached, or when the Wi-Fi connection has been established, the hidden condition is determined to be satisfied.

14. The method according to claim 1, wherein
the device other than the terminal has a near field communication tag.

15. The method according to claim 5, wherein
the device other than the terminal has a near field communication tag.

16. The terminal according to claim 10, wherein
the device other than the terminal has a near field communication tag.
